(19) United States
(12) Patent Application Publication
(10) Pub. No.: US 2025/0181397 A1
(43) Pub. Date: Jun. 5, 2025

(54) ENVIRONMENTAL IMPACT-BASED SCHEDULING INTERFACE FOR CONTROLLING COMPUTING OPERATIONS

(71) Applicant: SAP SE, Walldorf (DE)

(72) Inventor: Alexander Semke, Weinheim (DE)

(73) Assignee: SAP SE, Walldorf (DE)

(21) Appl. No.: 18/527,029

(22) Filed: Dec. 1, 2023

(51) Int. Cl. G06F 9/50

(52) U.S. Cl. CPC G06F 9/5027

(57) ABSTRACT

Systems and processes for providing an environmental impact-based scheduling interface for scheduling computing operations are provided. In a method for providing the scheduling interface, environmentally-friendly time slots for performing the computing operation may be identified. The environmentally-friendly time slots may correspond to times at which an environmental impact of performing the computing operation is below a threshold. A user interface may be updated to present the environmentally-friendly time slots to a user of the user interface, and the computing operation may be scheduled to be performed at a selected environmentally-friendly time slot that is selected via the user interface.

### BACKGROUND

Data operations and/or other computing jobs utilize computing resources such as computer processors, storage devices, memory, and/or other elements of computing systems, each of which consume power for operation. As the complexity of computing jobs increase, the amount of computing resources used and the amount of time that computing resources are used increases, thereby increasing power demand for completing the jobs.

Some computing systems enable users to schedule performance of computing jobs so that the jobs may be completed in accordance with timing concerns or other considerations. However, users may also be interested in considering environmental impacts for the computing job alongside of other timing concerns. Accordingly, there remains a need for improved technologies to provide interfaces for indicating environmental impacts when scheduling computing operations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In summary, the detailed description is directed to various innovative technologies for providing an interface for scheduling computing operations in consideration of environmental impacts of performing the computing operations. In some examples, the disclosed technologies can be implemented as computer-readable media storing instructions which, when executed by one or more hardware processors, cause the hardware processors to perform the following actions. A request may be received to schedule a computing operation to be performed. Environmentally-friendly time slots for performing the computing operation may be identified, wherein the environmentally-friendly time slots correspond to times at which an environmental impact of performing the computing operation is below a threshold. A user interface may be updated to present the environmentally-friendly time slots to a user of the user interface. A selection of a selected time slot of the environmentally-friendly time slots may be received via the user interface. An indication may be sent to control a scheduling service to schedule the computing operation to be performed at the selected time slot.

In some examples, the disclosed technologies can be implemented as a method performed by a computer. In the method, a request to schedule a computing operation may be received. A computing system at which the computing operation is to be performed may be determined. Environmentally-friendly time slots for the computing system may be determined, wherein the environmentally-friendly time slots correspond to times at which an environmental impact of performing the computing operation at the computing system is below a threshold. An update may be sent to a scheduling user interface to control the user interface to present the environmentally-friendly time slots to a user. An indication of a selection of a selected time slot of the environmentally-friendly time slots by the user via the user interface may be received. A scheduler service may be controlled to schedule the computing operation to be performed by the computing system at the selected time slot.

In some examples, the disclosed technologies can be implemented in a system including one or more hardware processors with coupled memory, and computer-readable media storing instructions executable by the one or more hardware processors. The instructions include first, second, third, fourth, and fifth instructions. The first instructions, when executed, cause a scheduling user interface to be presented for scheduling a computer operation to be performed by a computing system. The second instructions, when executed, cause environmentally-friendly time slots for performing the computing operation at the computing system to be identified, wherein the environmentally-friendly time slots correspond to times at which an environmental impact of performing the computing operation at the computing system is below a threshold. The third instructions, when executed, cause the user interface to be updated to present the environmentally-friendly time slots to a user of the user interface via a scheduling widget that shows the environmentally-friendly time slots as visually differentiated from other time slots. The fourth instructions, when executed, cause a selection of a selected time slot of the environmentally-friendly time slots via the user interface to be received. The fifth instructions, when executed, cause an indication to be sent to control a scheduling service to schedule the computing operation to be performed by the computing system at the selected time slot.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example system for providing an interface for indicating environmentally-friendly time frames for performing computing operations in accordance with examples of the present disclosure.

FIG. 2 is a flow chart for performing environmental impact-based scheduling using a corresponding scheduling user interface in accordance with examples of the present disclosure.

FIG. 3 is an example user interface for scheduling computing operations in accordance with examples of the present disclosure.

FIG. 4 is an example user interface for scheduling computing operations using a calendar interface in accordance with examples of the present disclosure.

FIG. 5 is an example user interface for scheduling computing operations using a calendar interface that shows environmentally-friendly time slots for the computing operations in accordance with examples of the present disclosure.

FIG. 6 is a flow chart for providing a user interface that presents environmentally-friendly time slots for scheduling performance of computing operations in accordance with examples of the present disclosure.

FIG. 7 is a diagram schematically depicting a computing environment suitable for implementation of disclosed technologies.

FIG. 8 is a diagram schematically depicting computing devices operating in conjunction with a computing cloud for implementation of disclosed technologies.

### DETAILED DESCRIPTION

### Introduction and Overview

As described above, computing operations may be computing resource-intensive, and, in turn, demand significant power for completion. Computing systems, such as data centers, servers, and/or other computing devices, may be powered by various power sources at different times. A power mix for a data center or other computing system may refer to a mix of power sources that collectively power the data center or other computing system and/or a mix of types of power used to power the data center or other computing system, which may be expressed as a percentage or amount of different energy resources and/or power sources used for operating the data center or other computing system. For example, data centers that utilize solar power may be powered exclusively or mostly by solar power during the day and/or on clear days, however, power from a non-renewable energy resource (e.g., a power grid that generates power using non-renewable energy) may be used at nighttime and/or on cloudy/overcast day when solar power generation is significantly reduced or unavailable. Accordingly, the environmental impact of using the computing resources when non-renewable energy resources are used (or when non-renewable energy resources contribute to a relatively larger percentage of a power mix) may be greater than when using the computing resources when renewable energy resources are used (or when non-renewable energy resources contribute to a relatively smaller percentage of the power mix).

In some systems, computational jobs may be automatically scheduled based on a type of energy available to power corresponding computing systems that perform the computational jobs to reduce an environmental impact (e.g., a CO₂ or carbon footprint) of the computational job. However, such automatic scheduling fails to consider user preferences or concerns for timing of the job. Furthermore, for such automatic scheduling, users remain uninformed regarding the environmental impact of the job or the operational characteristics of the computing systems/data centers performing the computing job.

This disclosure describes a new approach to provide an interface that indicates environmentally-friendly time slots for scheduling computing operations. The disclosed technologies enable users to easily schedule computing operations to be performed at a time that is both sufficient for parameters of the operation and considers the environmental impact of performing the operation. The disclosed technologies also cause the user to be actively invited to participate in decisions to reduce environmental impact of data operations, which may remind the user to consider such impacts in other applications. The disclosed technologies may provide an environmental impact-based scheduling interface for use in a variety of applications, such as cloud-based analytic computing, machine learning model training, large-scale computational processes (e.g., for academic, medical, and/or research purposes), computing system update rollouts, and other data processing, examples of which are described in more detail below.

### Example System

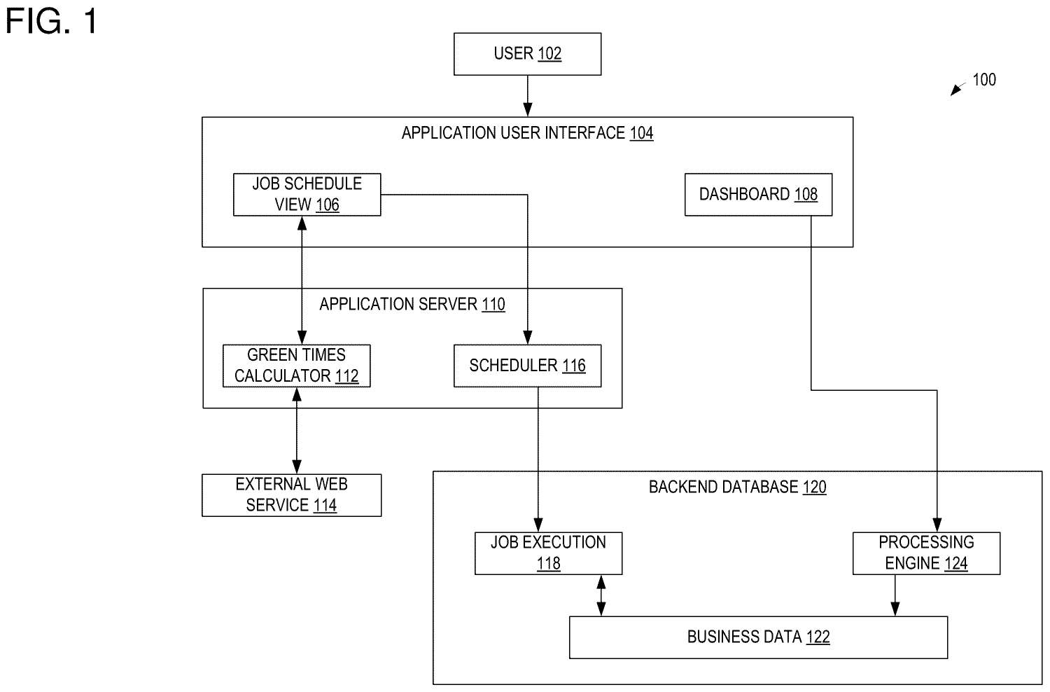

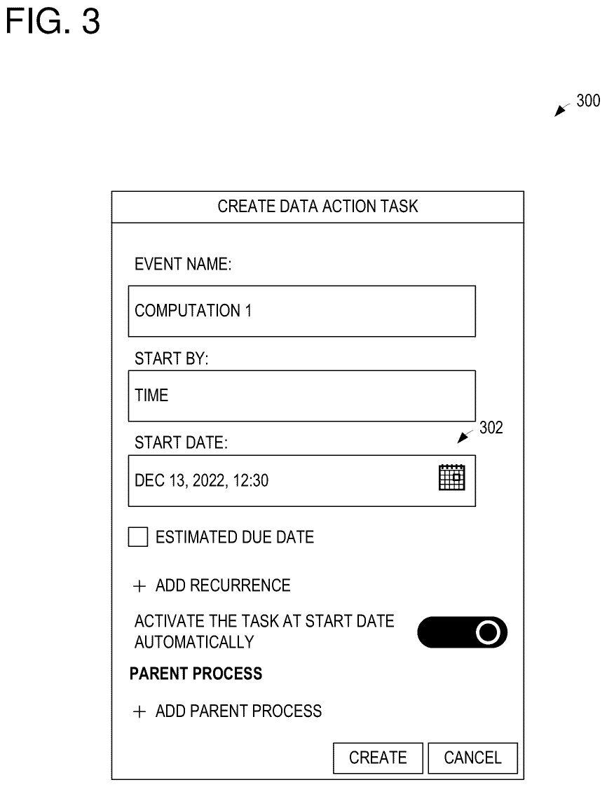

FIG. 1 shows an example block diagram of a system 100 for providing an interface for indicating environmentally-friendly time frames for performing computing operations in accordance with examples of the present disclosure. In some examples, a user 102 may access an application user interface 104, which enables the user to interact with other systems using various views, such as job schedule view 106 and dashboard 108. For example, the job schedule view 106 may be used to provide information usable by an application server 110 to schedule operation of computing jobs or other data processing operations. Examples relating to the job schedule view 106 are described in more detail below with respect to FIGS. 3-5.

The application server 110 may include a green times calculator 112, which is configured to determine green times at which a data center(s) or other computing system(s) utilize “green” energy (e.g., renewable resources) for power. For example, the green times may be determined to be times at which the data center(s) or other computing system(s) have historically and/or are scheduled to utilize renewable energy resources to generate at least a threshold percentage (e.g., 100%, 85%, etc.) of the power demand for a targeted job to be scheduled. In order to determine the green times, the green times calculator 112 may determine a data center(s) or other computing system(s) that is to be used for the targeted job (e.g., based on parameters of the job request received form the job schedule view 106 and/or based on information from a scheduler 116, which may identify the data center(s) or other computing system(s) based on the parameters of the job request), and then access an external web service 114 or other resource to identify energy consumption information (e.g., data regarding energy usage such as a percentage or mix of power sources, also referred to as a power mix as described above, used to power the data center(s) or other computing system(s)). For example, the green times calculator 112 may generate one or more queries to request the energy consumption information for the data center(s) or other computing system(s) from the external web service 114. In some examples, multiple external web services 114 may be accessed by the green times calculator 112 to determine the green times, where the green times are selected based on an aggregation of data from the multiple external web services 114. The external web services 114 may include direct information sources such as power suppliers for the data center(s) or other computing system(s) and/or third-party sources such as government data sources or other data sources that collect power information. The external web services 114 may be selected based on a location of the data center(s) or other computing system(s) and/or queries provided to the external web services 114 may include an indication of the data center(s) or other computing system(s) in order to retrieve relevant power information for the data center(s) or other computing system(s).

Using the information received from the external web services 114, the green time calculator 112 may process the information to determine green time slots. In some examples, the green time calculator 112 may process the information received from the external web services 114 and/or enrich the data received from the external web services 114 (e.g., determining additional metrics such as a quality of a power mix, information regarding a power grid supplying the data center(s) and/or other computing system(s), forecast information indicating how a power mix may (or is expected to) look in a specified period of time or at different periods of time, etc.) in order to determine the green time slots. Green time slots may include times at which the data center(s) or other computing system(s) are powered using renewable energy sources. For example, an administrator or other controlling user or entity may define parameters for identifying a green time slot (e.g., green time slots may be determined to have at least a threshold percentage or amount of power that is generated using renewable resources, or may be determined to be times at which a carbon footprint or emission for performing a computing job is below an emission threshold, where the threshold(s) are defined by the administrator/other entity and/or set as a default value).

The green times calculator 112 may provide the green times back to the job schedule view 106 to enable the user 102 to view the available green times to schedule the job. Upon selection of a time (e.g., one of the green times), an indication of the time and/or other parameters of the job are provided to the scheduler 116 to schedule operation of the job at the requested time. The scheduler 116 sends the information for the job to a job execution service 118 of a backend database 120 to schedule the job for execution at the data center(s) or other computing system(s). Once the scheduled time is reached, the job execution service 118 accesses business data 122 to perform the requested job at the scheduled time (e.g., while the data center(s) or other computing system(s) are powered by renewable energy). The dashboard 108 may be used to view scheduled jobs and/or a status of current, past, or future scheduled jobs by accessing a processing engine 124 of the backend database 120. In some examples, the dashboard 108 may be used to view other information, such as all or a portion of the data or enriched data from the external web services 114 described above. For example, the dashboard 108 may enable a user to view a forecast of carbon emissions or a forecast of a percentage of power originating from renewable energy resources for scheduled jobs. The dashboard 108 may further enable a user to reschedule jobs (e.g., bringing the user to the job schedule view 106 for adjusting an existing job) to select green (or greener) time slots to reduce carbon emissions and/or increase a percentage of power originating from renewable energy resources for the scheduled jobs. The dashboard 108 may provide visualizations (e.g., graphs, trends, tables, etc.) of green energy usage over time, recommendations for increasing green energy usage, progress toward green energy usage goals, etc.

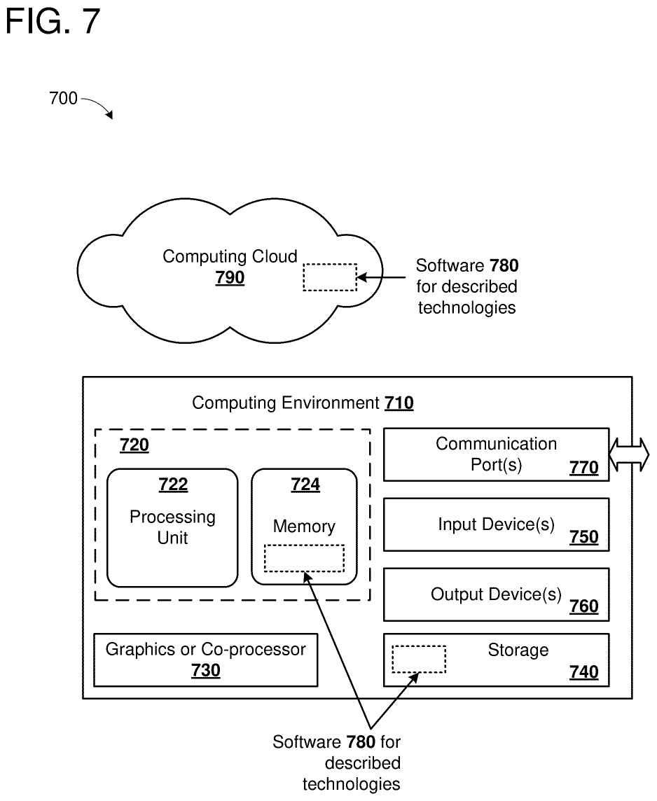

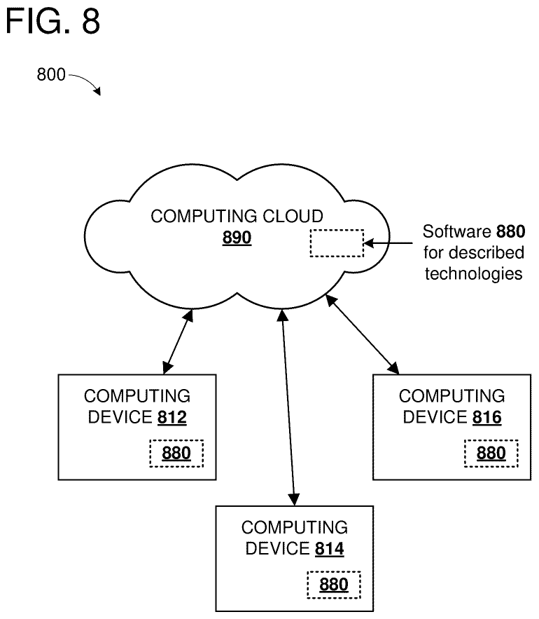

The components of FIG. 1, including the application user interface 104, the application server 110, the backend database 120, the external web service 114, and/or the components included therein may include and/or be implemented in accordance with one or more computing systems or environments, examples of which are described in more detail below with respect to FIGS. 7 and 8 below.

### Example Method—Scheduling Computing Operations Using Environmental Impact-Based Interface

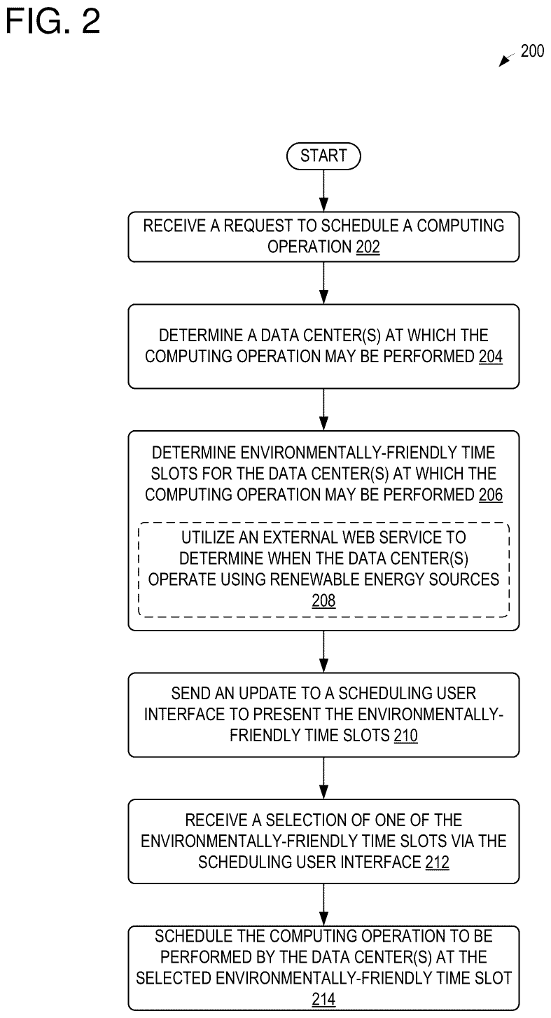

FIG. 2 is a flowchart of an example method 200 for performing environmental impact-based scheduling using a corresponding scheduling user interface in accordance with one or more examples of the present disclosure. For example, method 200 may be performed by one or more components of a system, such as a system 100 of FIG. 1. In some examples, method 200 may be performed by executing instructions of an application user interface or application server and/or other components described above with respect to FIG. 1.

At 202, the method includes receiving a request to schedule a computing operation. For example, the request may be received using an environmental impact-based user interface that is configured to show green times for performing computing operations at a data center. As used herein, references to a data center are understood to include one or more data centers or other computing system(s) at which a computing operation (e.g., a data processing or other computing job) may be performed.

At 204, the method includes determining a data center(s) at which the computing operation may be performed. For example, as described above, the data center may be determined based on parameters of the request, such as a type of computing operation, data to be processed for performing the computing operation, availability of different data centers, etc.

At 206, the method includes determining environmentally-friendly time slots (e.g., “green” time slots, as described above) for the data center(s) at which the computing operation may be performed. For example, as indicated at 208 and as described above with respect to FIG. 1, an external web service may be utilized to determine when the data center(s) operate using renewable energy sources, and the environmentally-friendly time slots may include time slots at which the data center(s) use the renewable energy for powering computing components (or at least a threshold percentage of the energy used for powering computing components is derived from renewable energy sources).

At 210, the method includes sending an update to a scheduling user interface to show the environmentally-friendly time slots. For example, a calendar or scheduling widget or other user interface element or control may show the environmentally-friendly time slots (e.g., in a clock, in a list, in a table, etc.) by highlighting or otherwise visually differentiating the environmentally-friendly time slots relative to other (e.g., non-environmentally-friendly) time slots. In other examples, only the environmentally-friendly time slots may be shown in the user interface for selection.

At 212, the method includes receiving a selection of one of the environmentally-friendly time slots via the scheduling user interface. For example, the user may select one of the highlighted or otherwise presented environmentally-friendly time slots in the user interface to indicate the preference for that time slot. In some examples, the user may select multiple time slots (e.g., in order of preference) for use in determining a schedule for performing the computing operation.

At 214, the method includes scheduling the computer operation to be performed by the data center(s) at the selected environmentally-friendly time slot. For example, if one time slot is selected, the job may be scheduled at that time slot. If multiple time slots are selected, the time slot with the highest preference, the time slot with the lowest carbon footprint, and/or the time slot fitting one or more other criteria for selection by a scheduler may be selected for scheduling the performance of the computing operation.

### Example User Interface—Environmental Impact-Based Scheduling Interface

FIGS. 3-6 show example user interfaces for scheduling a computing operation (e.g., a data action task or other data operation) to be performed in consideration of environmental impacts of the performance of the computing operation. User interfaces 300, 400, and 500 shown in FIGS. 3-5, respectively, may be examples of one or more application user interfaces, such as application user interface 104 of FIG. 1, which coordinate with an application server, such as application server 110 of FIG. 1 to schedule jobs to be executed at a backend database, such as backend database 120 of FIG. 1. It is to be understood that the appearance of the user interfaces in FIGS. 3-5 are illustrative and non-limiting, and any suitable user interface appearance, views, mechanisms (e.g., user interface elements, user input device, support, etc.), and/or content may be employed to provide the functionality described herein relating to scheduling computing operations.

FIG. 3 shows an example user interface 300 for creating a new data action task (e.g., a new computing operation to be performed at a data center(s) or other computing system(s)). The user interface 300 may include various fields for inputting information such as a name for the task (e.g., “Computation 1” in the illustrated example), an indication of how the task is to be started (e.g., at a designated time in the illustrated example), and a start date for the task. For example, field 302 may be selectable to choose the start date by entering a desired start date for the task or using a widget or control to select the start date. Other parameters of the task may be provided by selecting other fields in the user interface 300, such as adding a recurrence of the task or adding a parent process for the task.

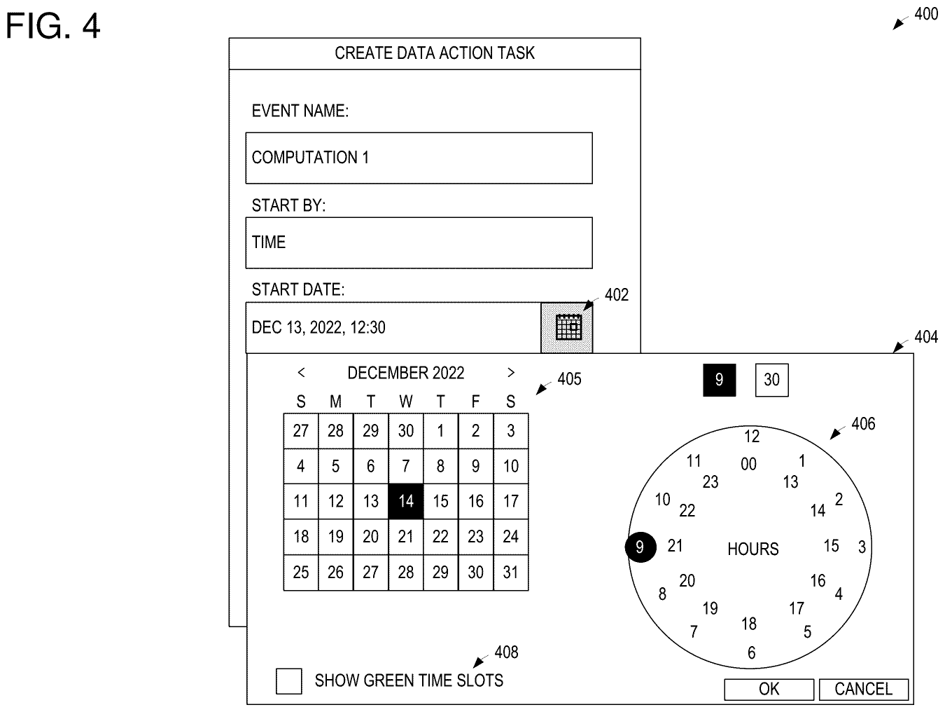

In order to ensure that the start date is selected to be a valid start date for a data center that is able to perform the task (e.g., to ensure the data center(s) that can perform the task are available at the start date), a widget for selecting the start date may be used, which shows a calendar view and selectable times for scheduling the task. For example, FIG. 4 shows an example user interface 400 that includes a scheduling widget 404 that is viewable responsive to selecting an icon 402 (e.g., a selectable user interface element) in a start date field of the user interface. The scheduling widget 404 may be a user interface element or control that includes a calendar portion 405 for selecting a day to start the task and a clock portion 406 for selecting a time to start the task. In the example of FIG. 4, an option for showing green time slots is unselected, as shown by the user interface element 408 that remains unchecked, so the calendar and clock portions of the scheduling widget 404 may not indicate times that are associated with green energy usage. The user interface element 408 may be selectable to toggle between showing or not showing green time slots.

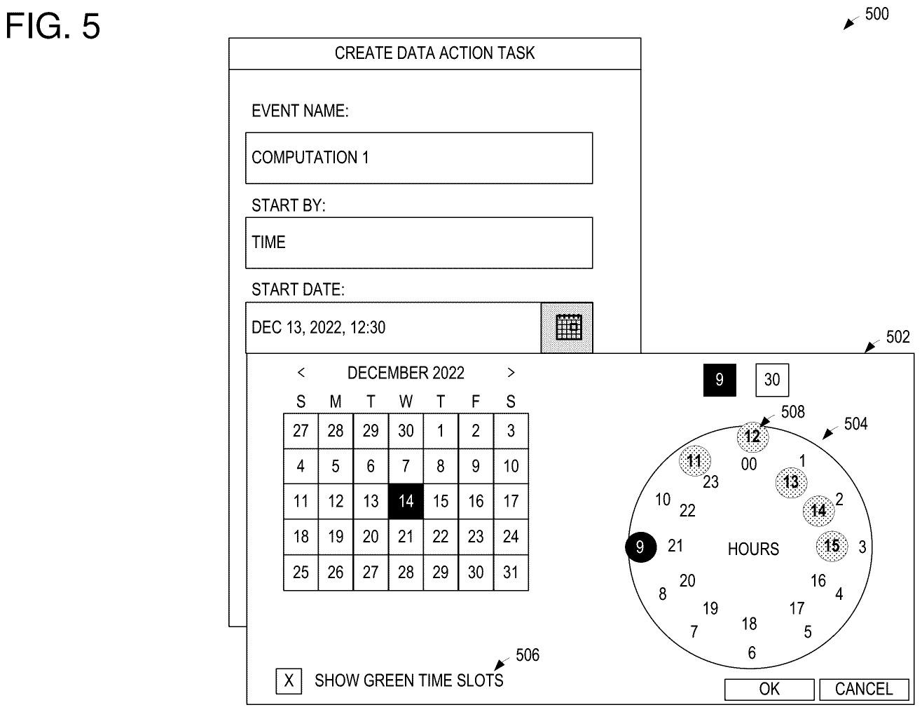

FIG. 5 shows an example user interface 500 that may be presented after a user selects to view green time slots. For example, a scheduling widget 502 may include a clock portion 504 that highlights times associated with green time slots responsive to selection of a user interface element 506 for an option to show green time slots. Although shown as an optional and selectable feature in the illustrated examples, it is to be understood that in other examples the green time slots may be shown by default and/or may be shown automatically without providing the user interface element 506 to toggle views between showing green time slots as visually differentiated from other time slots and not showing green time slots as visually differentiated from other time slots (e.g., showing green time slots as undifferentiated from other time slots). In some examples, rules may be set for controlling scheduling with respect to green times. For example, a rule may be set by an administrator or other user that controls the scheduler to only show and/or allow green time slots to be used for scheduling jobs under selected conditions, such as instances where an overall carbon footprint of existing jobs is above a threshold.

Green time slots may be shown on the clock portion 504 by way of highlighting hours that correspond to green time slots for a selected day, an example of which is shown at 508. For example, in the illustrated example, green time slots include 1100 hours, 1200 hours, 1300 hours, 1400 hours, and 1500 hours. It is to be understood that green time slots may be indicated in the scheduling widget 502 and/or the user interface 500 in any suitable manner, including showing a list or range of green time slots, de-highlighting non-green time slots (e.g., striking through, or otherwise indicating that the slots are not green time slots), and/or providing other indicators. In some examples, days that include green time slots may be indicated in a calendar portion of the scheduling widget.

As described above with respect to FIG. 1, in some examples, additional data and/or additional granularity regarding green time slots may be provided to users via the user interface 500. For example, the green time slots may be shown in different colors, patterns, or other graphical appearances to indicate levels of environmental impact for the respective time slots. For example, time slots having a highest percentage of renewable energy resource usage, such as 90-100% in an illustrative example, may be shown in a first color, such as green, while time slots having a lower percentage of renewable energy resource usage, such as 70-90% may be shown in a second color, such as yellow. Non-green time slots (e.g., time slots having below a threshold percentage of renewable energy resource usage, such as below 70%) may have no color or may be associated with a third color, such as red. The above-described color-coding is one example of showing different granularities of environmental impact for different time slots, and other graphical appearances may be used (e.g., color gradients, text size differentiation, text boldness differentiation, order of presentation of time slots, and/or other appearances) to indicate the different levels of environmental impact (e.g., different percentages of renewable energy resource usage, different carbon emission amounts, etc.).

### Example Method—Providing a User Interface for Green Time Slot Scheduling

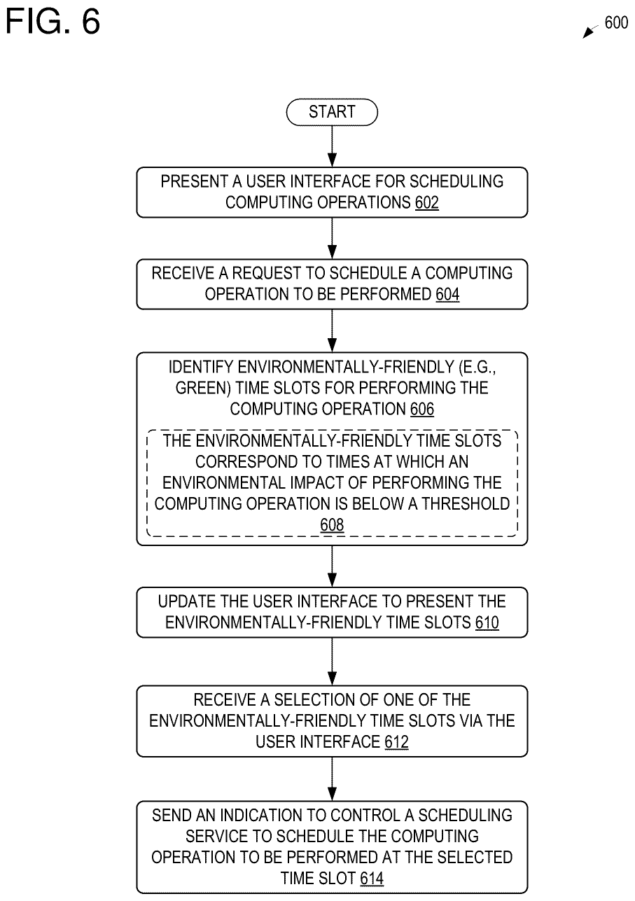

FIG. 6 is a flowchart of an example method 600 for providing a user interface that allows users to view and select green time slots for performing computing operations in accordance with one or more examples of the present disclosure. For example, method 600 may be performed by and/or in coordination with one or more components of a system, such as a system 100 of FIG. 1. In some examples, method 600 may be performed by executing instructions of an application server to utilize other components described above with respect to FIG. 1.

At 602, the method includes presenting a user interface for scheduling computing operations. For example, the user interfaces 300, 400, and 500 of FIGS. 3-5, respectively, may be examples of a scheduling user interface that is presented according to the method at 602. At 604, the method includes receiving a request to schedule a computing operation (e.g., a job, a data operation, a computation, etc.) to be performed. As described above, the user may have some (or no) constraints for the timing of the computing operation, however, there may be some flexibility as to the precise timing of performing the operation. Accordingly, the user interface may be used to allow a user to choose time slots that meet any timing constraints and also minimize or reduce an environmental impact of performing the computing operation.

At 606, the method includes identifying environmentally-friendly (e.g., green) time slots for performing the computing operation. For example, as indicated at 608, the environmentally-friendly time slots may correspond to times at which an environmental impact of performing the computing operation is below a threshold. More detailed and/or additional examples of environmentally-friendly/green time slots are described above with respect to FIGS. 1 and 2, and may define the time slots identified at 606. For example, the environmentally-friendly time slots may be identified based on information received from a calculator that retrieves information from one or more external web services regarding energy usage/consumption of a data center(s) that is able to (or will be assigned to) perform the computing operation, as described above.

At 610, the method includes updating the user interface to present the environmentally-friendly time slots. For example, as shown and described above with respect to FIG. 5, the environmentally-friendly time slots may be highlighted relative to other time slots and/or otherwise indicated in the user interface.

At 612, the method includes receiving a selection of one of the environmentally-friendly time slots via the user interface. For example, the environmentally-friendly time slots may be presented as selectable user interface elements in the user interface. At 614, the method includes sending an indication to control a scheduling service to schedule the computing operation to be performed at the selected time slot. For example, the computing operation may be scheduled to be performed at the data center(s) for which the environmentally-friendly time slots were identified at 606/608 at the selected time.

### Example Advantages

This solution is superior in comparison of approaches in the past with regards to at least the following considerations. The disclosed approach allows users to be empowered to actively contribute to carbon emission reduction and other environmental impact goals by providing a mechanism to allow the user to schedule computing operations to occur at times that minimize the environmental impact of the performance of the operations based on power consumption at data centers or other computing systems performing the operations. Currently, scheduling interfaces do not consider power consumption details of data centers, and do not allow a user to select times in consideration of power consumption profiles. The disclosed technologies, relative to prior systems, improves a user experience for scheduling computing operational tasks by providing a seamless user interface for visualizing available time slots for completing the tasks, and allows a user to take into account an environmental impact of the tasks.

### Additional Examples

A first example of the disclosed technologies includes one or more computer-readable media storing instructions which, when executed by one or more hardware processors, cause the hardware processors to perform actions comprising: receiving a request to schedule a computing operation to be performed, identifying environmentally-friendly time slots for performing the computing operation, wherein the environmentally-friendly time slots correspond to times at which an environmental impact of performing the computing operation is below a threshold, updating a user interface to present the environmentally-friendly time slots to a user of the user interface, receiving a selection of a selected time slot of the environmentally-friendly time slots via the user interface, and sending an indication to control a scheduling service to schedule the computing operation to be performed at the selected time slot.

A second example of the disclosed technologies includes the first example, and further includes the one or more computer-readable media, wherein identifying the environmentally-friendly time slots comprises receiving, from a calculator service, an indication of the environmentally-friendly time slots based on energy consumption information retrieved by the calculator service from one or more external web services.

A third example of the disclosed technologies includes one or both of the first example and the second example, and further includes the one or more computer-readable media, wherein the energy consumption information retrieved by the calculator service corresponds to a data center at which the computer operation is to be performed.

A fourth example of the disclosed technologies includes one or more of the first example through the third example, and further includes the one or more computer-readable media, wherein the environmentally-friendly time slots are presented to the user by visually differentiating the environmentally-friendly time slots from other time slots at which the environmental impact of performing the computing operation is at or above the threshold.

A fifth example of the disclosed technologies includes one or more of the first example through the fourth example, and further includes the one or more computer-readable media, wherein the user interface comprises a clock portion of a scheduling widget that shows selectable user interface elements corresponding to times at which the computing operation is able to be performed, and wherein the environmentally-friendly time slots are shown as a first set of the selectable user interface elements that are highlighted in the clock portion relative to the other time slots, which are shown as a second set of the selectable user interface elements.

A sixth example of the disclosed technologies includes one or more of the first example through the fifth example, and further includes the one or more computer-readable media, wherein the user interface includes a user interface element selectable to toggle between a first view in which the environmentally-friendly time slots are presented as visually differentiated from other time slots and a second view in which the environmentally-friendly time slots are presented as visually undifferentiated from the other time slots.

A seventh example of the disclosed technologies includes one or more of the first example through the sixth example, and further includes the one or more computer-readable media, wherein updating the user interface to present the environmentally-friendly time slots comprises providing a first, scheduling view of the user interface, and wherein the actions further comprise providing a second, dashboard view of the user interface, the second, dashboard view showing metrics relating to respective environmental impact metrics for scheduled computing operations.

An eighth example of the disclosed technologies includes one or more of the first example through the seventh example, and further includes the one or more computer-readable media, wherein the second, dashboard view includes one or more user interface elements that are selectable to change a timing of the scheduled computing operations by switching the user interface to the first, scheduling view.

A ninth example of the disclosed technologies includes one or more of the first example through the eighth example, and further includes the one or more computer-readable media, wherein the environmental impact for the times are respectively determined based on a respective percentage or mix of power sources expected to be used to power a data center at which the computing operation is to be performed.

A tenth example of the disclosed technologies includes one or more of the first example through the ninth example, and further includes the one or more computer-readable media, wherein the environmental impact for the times are respectively determined based on respective carbon emissions expected to be produced by the data center at which the computing operation is to be performed.

An eleventh example of the disclosed technologies includes a method performed by a computer, the method comprising: receiving a request to schedule a computing operation, determining a computing system at which the computing operation is to be performed, determining environmentally-friendly time slots for the computing system, wherein the environmentally-friendly time slots correspond to times at which an environmental impact of performing the computing operation at the computing system is below a threshold, sending an update to a scheduling user interface to control the user interface to present the environmentally-friendly time slots to a user, receiving an indication of a selection of a selected time slot of the environmentally-friendly time slots by the user via the user interface, and controlling a scheduler service to schedule the computing operation to be performed by the computing system at the selected time slot.

A twelfth example of the disclosed technologies includes the eleventh example, and further includes the method, wherein determining the environmentally-friendly time slots comprises retrieving information from one or more external web services to determine when the computing system operates using a power mix that includes at least a threshold percentage or amount of renewable energy sources.

A thirteenth example of the disclosed technologies includes one or both of the eleventh example and the twelfth example, and further includes the method, wherein determining the environmentally-friendly time slots comprises retrieving information from one or more external web services to determine when the computing system is able to generate less than a threshold amount of carbon emissions while performing the computing operation.

A fourteenth example of the disclosed technologies includes one or more of the eleventh example through the thirteenth example, and further includes the method, wherein determining the environmentally-friendly time slots comprises retrieving energy consumption information from one or more external web services and enriching the energy consumption information by determining additional metrics including one or more of a quality of a power mix for the computing system, information regarding a power grid supplying power to the computing system, or forecast information indicating how a power mix is expected to look in at different periods of time.

A fifteenth example of the disclosed technologies includes one or more of the eleventh example through the fourteenth example, and further includes the method, wherein at least a portion of the additional metrics are sent to update the scheduling user interface to present an indication of the additional metrics to the user.

A sixteenth example of the disclosed technologies includes one or more of the eleventh example through the fifteenth example, and further includes the method, wherein determining the environmentally-friendly time slots for the computing system comprises respectively determining different levels of environmental impact for the environmentally-friendly time slots, and wherein sending the update to the scheduling user interface comprises sending an indication of the different levels of environmental impact for the environmentally-friendly time slots to control the user interface to present each of the environmentally-friendly time slots with a visual indication of a corresponding respective level of environmental impact.

A seventeenth example of the disclosed technologies includes a system, comprising: one or more hardware processors with memory coupled thereto, and computer-readable media storing instructions executable by the one or more hardware processors, the instructions comprising: first instructions to present a scheduling user interface for scheduling a computer operation to be performed by a computing system, second instructions to identify environmentally-friendly time slots for performing the computing operation at the computing system, wherein the environmentally-friendly time slots correspond to times at which an environmental impact of performing the computing operation at the computing system is below a threshold, third instructions to update the user interface to present the environmentally-friendly time slots to a user of the user interface via a scheduling widget that shows the environmentally-friendly time slots as visually differentiated from other time slots, fourth instructions to receive a selection of a selected time slot of the environmentally-friendly time slots via the user interface, and fifth instructions to send an indication to control a scheduling service to schedule the computing operation to be performed by the computing system at the selected time slot.

An eighteenth example of the disclosed technologies includes the seventeenth example, and further includes the system, wherein the environmentally-friendly time slots are visually differentiated from the other time slots by highlighting the environmentally-friendly time slots.

A nineteenth example of the disclosed technologies includes one or both of the seventeenth example and the eighteenth example, and further includes the system, wherein the highlighting for the environmentally-friendly time slots is respectively presented with a color, gradient, or pattern that is based on a respective level of environmental impact of performing the computing operation at the environmentally-friendly time slots.

A twentieth example of the disclosed technologies includes one or more of the seventeenth example through the nineteenth example, and further includes the system, wherein the environmental impact is determined in terms of a percentage of power provided by renewable energy resources used to perform the computing operation or in terms of an amount of carbon emissions generated by performance of the computing operation.

### A Generalized Computer Environment

FIG. 7 illustrates a generalized example of a suitable computing system 700 in which described examples, techniques, and technologies, including scheduling computing operations in an environmental impact-based scheduling interface according to disclosed technologies can be implemented. For example, the computing system 700 and/or one or more elements of the computing system 700 may include and/or be included within one or more of the described components of system 100 of FIG. 1 and/or be used to perform operations described in correspondence to FIGS. 2-6. The computing system 700 is not intended to suggest any limitation as to scope of use or functionality of the present disclosure, as the innovations can be implemented in diverse general-purpose or special-purpose computing systems.

With reference to FIG. 7, computing environment 710 includes one or more processing units 722 and memory 724. In FIG. 7, this basic configuration 720 is included within a dashed line. Processing unit 722 executes computer-executable instructions, such as for implementing any of the methods or objects described herein for performing annotation word-to-token alignment, or various other architectures, components, handlers, managers, modules, or services described herein. Processing unit 722 can be a general-purpose central processing unit (CPU), a processor in an application-specific integrated circuit (ASIC), or any other type of processor. In a multi-processing system, multiple processing units execute computer-executable instructions to increase processing power. Computing environment 710 can also include a graphics processing unit or co-processing unit 730. Tangible memory 724 can be volatile memory (e.g., registers, cache, or RAM), non-volatile memory (e.g., ROM, EEPROM, or flash memory), or some combination thereof, accessible by processing units 722, 730. The memory 724 stores software 780 implementing one or more innovations described herein, in the form of computer-executable instructions suitable for execution by the processing unit(s) 722, 730. The memory 724 can also store footprint calculation data, a composite graph data structure, including nodes, edges, and their respective attributes; a table or other data structure indicating states of a modeled system, configuration data, User Interface (UI) displays, browser code, data structures including data tables, working tables, change logs, output structures, input fields, output fields, data values, indices, or flags, as well as other operational data.

A computing system 710 can have additional features, such as one or more of storage 740, input devices 750, output devices 760, or communication ports 770. An interconnection mechanism (not shown) such as a bus, controller, or network interconnects the components of the computing environment 710. Typically, operating system software (not shown) provides an operating environment for other software executing in the computing environment 710, and coordinates activities of the components of the computing environment 710.

The tangible storage 740 can be removable or non-removable, and includes magnetic disks, magnetic tapes or cassettes, CD-ROMs, DVDs, or any other medium which can be used to store information in a non-transitory way and which can be accessed within the computing environment 710. The storage 740 stores instructions of the software 780 (including instructions and/or data) implementing one or more innovations described herein.

The input device(s) 750 can be a mechanical, touch-sensing, or proximity-sensing input device such as a keyboard, mouse, pen, touchscreen, trackball, a voice input device, a scanning device, or another device that provides input to the computing environment 710. The output device(s) 760 can be a display, printer, speaker, optical disk writer, or another device that provides output from the computing environment 710.

The communication port(s) 770 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 700 can also include a computing cloud 790 in which instructions implementing all or a portion of the disclosed technology are executed. Any combination of memory 724, storage 740, and computing cloud 790 can be used to store software instructions and data of the disclosed technologies.

The present innovations can be described in the general context of computer-executable instructions, such as those included in program modules, being executed in a computing system on a target real or virtual processor. Generally, program modules or components include routines, programs, libraries, software objects, classes, components, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

FIG. 8 depicts an example cloud computing environment 800 in which the described technologies can be implemented. For example, the computing environment 800 and/or one or more elements of the computing environment 800 may include and/or be included within one or more of the described components of system 100 of FIG. 1 and/or be used to perform operations described in correspondence to FIGS. 2-6. The cloud computing environment 800 comprises a computing cloud 890 containing resources and providing services. The computing cloud 890 can comprise various types of cloud computing resources, such as computer servers, data storage repositories, networking resources, and so forth. The computing cloud 890 can be centrally located (e.g., provided by a data center of a business or organization) or distributed (e.g., provided by various computing resources located at different locations, such as different data centers and/or located in different cities or countries).

The computing cloud 890 can be operatively connected to various types of computing devices (e.g., client computing devices), such as computing devices 812, 814, and 816, and can provide a range of computing services thereto. One or more of computing devices 812, 814, and 816 can be computers (e.g., servers, virtual machines, embedded systems, desktop, or laptop computers), mobile devices (e.g., tablet computers, smartphones, or wearable appliances), or other types of computing devices. Communication links between computing cloud 890 and computing devices 812, 814, and 816 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 812, 814, and 816 can also be connected to each other.

Computing devices 812, 814, and 816 can utilize the computing cloud 890 to obtain computing services and perform computing operations (e.g., data processing, data storage, and the like). Particularly, software 880 for performing the described innovative technologies can be resident or executed in the computing cloud 890, in computing devices 812, 814, and 816, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and does not exclude the presence of intermediate elements between the coupled items. Furthermore, as used herein, the terms “or” and “and/or” mean any one item or combination of items in the phrase.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 7, computer-readable storage media include memory 724, and storage 740. The term computer-readable storage media does not include signals and carrier waves. In addition, the term computer-readable storage media does not include communication ports (e.g., 770) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, Angular, C, C++, C#, Curl, Dart, Fortran, Go, Java, JavaScript, Julia, Lisp, Matlab, Octave, Perl, Python, R, Ruby, SAS, SPSS, WebAssembly, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. One or more computer-readable media storing instructions which, when executed by one or more hardware processors, cause the hardware processors to perform actions comprising:
receiving a request to schedule a computing operation to be performed;
identifying environmentally-friendly time slots for performing the computing operation, wherein the environmentally-friendly time slots correspond to times at which an environmental impact of performing the computing operation is below a threshold;
updating a user interface to present the environmentally-friendly time slots to a user of the user interface;
receiving a selection of a selected time slot of the environmentally-friendly time slots via the user interface; and
sending an indication to control a scheduling service to schedule the computing operation to be performed at the selected time slot.

2. The one or more computer-readable media of claim 1, wherein identifying the environmentally-friendly time slots comprises receiving, from a calculator service, an indication of the environmentally-friendly time slots based on energy consumption information retrieved by the calculator service from one or more external web services.

3. The one or more computer-readable media of claim 2, wherein the energy consumption information retrieved by the calculator service corresponds to a data center at which the computer operation is to be performed.

4. The one or more computer-readable media of claim 1, wherein the environmentally-friendly time slots are presented to the user by visually differentiating the environmentally-friendly time slots from other time slots at which the environmental impact of performing the computing operation is at or above the threshold.

5. The one or more computer-readable media of claim 4, wherein the user interface comprises a clock portion of a scheduling widget that shows selectable user interface elements corresponding to times at which the computing operation is able to be performed, and wherein the environmentally-friendly time slots are shown as a first set of the selectable user interface elements that are highlighted in the clock portion relative to the other time slots, which are shown as a second set of the selectable user interface elements.

6. The one or more computer-readable media of claim 1, wherein the user interface includes a user interface element selectable to toggle between a first view in which the environmentally-friendly time slots are presented as visually differentiated from other time slots and a second view in which the environmentally-friendly time slots are presented as visually undifferentiated from the other time slots.

7. The one or more computer-readable media of claim 1, wherein updating the user interface to present the environmentally-friendly time slots comprises providing a first, scheduling view of the user interface, and wherein the actions further comprise providing a second, dashboard view of the user interface, the second, dashboard view showing metrics relating to respective environmental impact metrics for scheduled computing operations.

8. The one or more computer-readable media of claim 7, wherein the second, dashboard view includes one or more user interface elements that are selectable to change a timing of the scheduled computing operations by switching the user interface to the first, scheduling view.

9. The one or more computer-readable media of claim 1, wherein the environmental impact for the times is respectively determined based on a respective percentage or mix of power sources expected to be used to power a data center at which the computing operation is to be performed.

10. The one or more computer-readable media of claim 1, wherein the environmental impact for the times is respectively determined based on respective carbon emissions expected to be produced by a data center at which the computing operation is to be performed.

11. A method performed by a computer, the method comprising:
receiving a request to schedule a computing operation;
determining a computing system at which the computing operation is to be performed;
determining environmentally-friendly time slots for the computing system,
wherein the environmentally-friendly time slots correspond to times at which an environmental impact of performing the computing operation at the computing system is below a threshold;
sending an update to a scheduling user interface to control the user interface to present the environmentally-friendly time slots to a user;
receiving an indication of a selection of a selected time slot of the environmentally-friendly time slots by the user via the user interface; and
controlling a scheduler service to schedule the computing operation to be performed by the computing system at the selected time slot.

12. The method of claim 11, wherein determining the environmentally-friendly time slots comprises retrieving information from one or more external web services to determine when the computing system operates using a power mix that includes at least a threshold percentage or amount of renewable energy sources.

13. The method of claim 11, wherein determining the environmentally-friendly time slots comprises retrieving information from one or more external web services to determine when the computing system is able to generate less than a threshold amount of carbon emissions while performing the computing operation.

14. The method of claim 11, wherein determining the environmentally-friendly time slots comprises retrieving energy consumption information from one or more external web services and enriching the energy consumption information by determining additional metrics including one or more of a quality of a power mix for the computing system, information regarding a power grid supplying power to the computing system, or forecast information indicating how a power mix is expected to look in at different periods of time.

15. The method of claim 14, wherein at least a portion of the additional metrics are sent to update the scheduling user interface to present an indication of the additional metrics to the user.

16. The method of claim 11, wherein determining the environmentally-friendly time slots for the computing system comprises respectively determining different levels of environmental impact for the environmentally-friendly time slots, and wherein sending the update to the scheduling user interface comprises sending an indication of the different levels of environmental impact for the environmentally-friendly time slots to control the user interface to present each of the environmentally-friendly time slots with a visual indication of a corresponding respective level of environmental impact.

17. A system, comprising:
one or more hardware processors with memory coupled thereto; and
computer-readable media storing instructions executable by the one or more hardware processors, the instructions comprising:
first instructions to present a scheduling user interface for scheduling a computer operation to be performed by a computing system;
second instructions to identify environmentally-friendly time slots for performing the computing operation at the computing system, wherein the environmentally-friendly time slots correspond to times at which an environmental impact of performing the computing operation at the computing system is below a threshold;
third instructions to update the user interface to present the environmentally-friendly time slots to a user of the user interface via a scheduling widget that shows the environmentally-friendly time slots as visually differentiated from other time slots;
fourth instructions to receive a selection of a selected time slot of the environmentally-friendly time slots via the user interface; and
fifth instructions to send an indication to control a scheduling service to schedule the computing operation to be performed by the computing system at the selected time slot.

18. The system of claim 17, wherein the environmentally-friendly time slots are visually differentiated from the other time slots by highlighting the environmentally-friendly time slots.

19. The system of claim 18, wherein the highlighting for the environmentally-friendly time slots is respectively presented with a color, gradient, or pattern that is based on a respective level of environmental impact of performing the computing operation at the environmentally-friendly time slots.

20. The system of claim 17, wherein the environmental impact is determined in terms of a percentage of power provided by renewable energy resources used to perform the computing operation or in terms of an amount of carbon emissions generated by performance of the computing operation.
